(19) United States
(12) Patent Application Publication
(10) Pub. No.: US 2006/0117134 A1
(43) Pub. Date: Jun. 1, 2006

(54) System and method for prolonging usage lifetime of a non-volatile memory

(75) Inventor: Mien-Chih Chen, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/285,260

(22) Filed: Nov. 21, 2005

(30) Foreign Application Priority Data
Nov. 26, 2004 (TW) 93136473

(51) Int. Cl. G06F 12/00

(52) U.S. Cl. 711/103

(57) ABSTRACT

A system for prolonging usage lifetime of a non-volatile memory includes a non-volatile memory (1) and a host (2). The non-volatile memory is logically divided into a plurality of sectors (10), each of which stores a sector tag and data. The host includes a data writing module (20), a sector tag writing module (21), a sector tag checking module (22), and a data pointer (23). The data writing module is used for writing data into each sector, and reading data from each sector. The sector-tag writing module is used for writing a type of sector tag into each sector according to a sector tag writing rule. The sector tag checking module is used for checking a type of sector tag of each sector in order to determine a sector which data should be written into, and determine which type of sector tag should be written into the sector. The data pointer is used for pointing at a location of the sector to be read and written the sector tag and data. A related method is also disclosed.

### BACKGROUND OF THE INVENTION

1. Field of the Invention

The present invention relates to a system and method for using a non-volatile memory, and more particularly to a system and method for prolonging usage lifetime of a non-volatile memory.

2. General Background

In recent years, a non-volatile memory which holds data even in a power-off state has been realized by using a ferroelectric material. As we all known, a flash read only memory (ROM), an electrically erasable programmable read only memory (EEPROM), and a ferroelectric-based random access memory (FRAM) are all kinds of the non-volatile memory. More recent work with the non-volatile memory has shown many advantages over other memory technologies, such as Flash ROM or FRAM is able to operate in high-speed with low-voltage, ferroelectric-based memories do not require an overly complicated construction, and allow non-volatile storage.

Generally, a non-volatile memory is logically divided into a plurality of sectors for storing data. The sectors of the non-volatile memory may be destroyed when repeatedly operating mass data. In the process of producing disks, for example, the disks need to be tested by operating mass data by manufacturers to ensure validity of the disks. In order to cut down the production cost, a non-volatile memory may replace the disk to be tested, because of its high-speed. However, if a host can not write data into every sector of the non-volatile memory averagely, usage lifetime of the non-volatile memory is limited. In present, a method of randomly writing data into every sector is applied to make use of all sectors of the non-volatile memory. However, the random method can not ensure making use of all the sectors completely either.

What is needed, therefore, is a computer system for prolonging usage lifetime of a non-volatile memory, which can make full use of every sector of the non-volatile memory.

Similarly, what is also needed is a computerized method for prolonging usage lifetime of a non-volatile memory, which can make full use of every sector of the non-volatile memory.

### SUMMARY

A computer system for prolonging usage lifetime of a non-volatile memory in accordance with a preferred embodiment includes a non-volatile memory and a host. The non-volatile memory is logically divided into a plurality of sectors, each of which stores a sector-tag and data. The host includes a data writing module, a sector tag writing module, a sector tag checking module, and a data pointer. The data writing module is used for writing data into each sector of the non-volatile memory, and reading data from each sector. The sector-tag writing module is used for writing a type of sector tag into each sector of the non-volatile memory according to a sector tag writing rule. The sector tag checking module is used for checking a type of sector tag of each sector of the non-volatile memory, in order to determine a sector which data should be written into, and determine which type of sector tag should be written into the sector. The data pointer is used for pointing at a location of the sector to be read and written the sector tag and data.

Another preferred embodiment provides a computerized method for prolonging usage lifetime of a non-volatile memory by utilizing the above system. The method includes the steps: (a) dividing the non volatile memory into a plurality of sectors, each of the sectors being for storing a sector tag and data; (b) determining a sector of the non-volatile memory which data should be written into; (c) writing a sector tag into the sector according to a sector tag writing rule; and (d) writing data into the corresponding sector.

The step (b) includes the steps of: (b1) identifying a type of sector tag in the first sector of the non-volatile memory; (b2) checking a type of sector tag in a next sector of the non-volatile memory; (b3) determining whether the sector tag of the sector is the same as the sector tag in the first sector; (b4) returning to the step (b1), if the sector tag of the sector is the same as the sector tag in the first sector; and (b5) determining the sector is the sector which data should be written into, if the sector tag of the sector is not the same as the sector tag in the first sector.

Other advantages and novel features of the embodiments will be drawn from the following detailed description with reference to the attached drawings, in which:

### BRIEF DESCRIPTION OF THE DRAWINGS

FIG. 1 is a schematic diagram of a computer system for prolonging usage lifetime of a non-volatile memory according to a preferred embodiment of the present invention;

FIG. 2 is a flowchart of a preferred method for prolonging usage lifetime of a non-volatile memory by implementing the system of FIG. 1; and

FIG. 3A-3E are schematic diagrams of five instances for writing data into sectors of a non-volatile memory.

### DETAILED DESCRIPTION OF THE EMBODIMENTS

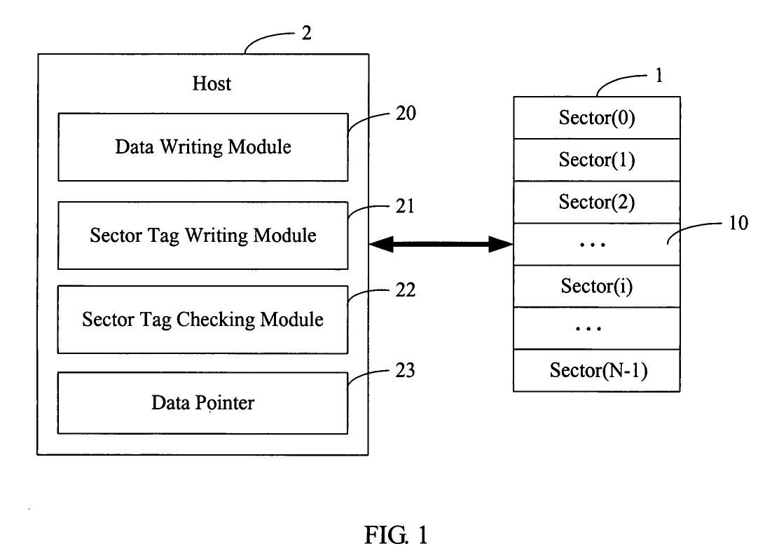

FIG. 1 is a schematic diagram of a computer system for prolonging usage lifetime of a non-volatile memory (hereinafter, “the system”) according to a preferred embodiment of the present invention. The system includes a non-volatile memory 1 and a host 2. The non-volatile memory 1 may be a flash read only memory (ROM), an electrically erasable programmable read only memory (EEPROM), or a ferroelectric-based random access memory (FRAM), which is logically divided into N sectors 10. The sectors 10 can be symbolically depicted as sector(0), sector(1), . . . , sector(i) . . . , and sector(N−1), each of which stores a sector tag and corresponding data. The sector tags are used for ensuring that data can be written into the sectors 10 of the non-volatile memory 1 averagely. In the preferred embodiment of the present invention, each sector tag may be a tag “x,” or a tag “y.”

The host 2 includes a data writing module 20, a sector tag writing module 21, a sector tag checking module 22, and a data pointer 23. The data writing module 20 is used for writing data into each sector 10, and reading data from each sector 10 of the non-volatile memory 1. The sector tag writing module 21 is used for writing a type of sector tag into each sector 10 according to the following rules: writing a tag “x” into the sector 10, if the data writing module 20 has written data into the sector 10 for odd times; and writing a tag “y” into the sector 10, if the data writing module 20 has written data into the sector 10 for even times. The sector tag checking module 22 is used for checking a type of sector tag of each sector 10, in order to determine a sector 10 which data should be written into, and determine which type of sector tag should be written into the sector 10. The data pointer 23 is used for pointing at a location of the sector 10 to be read and written a sector tag and data.

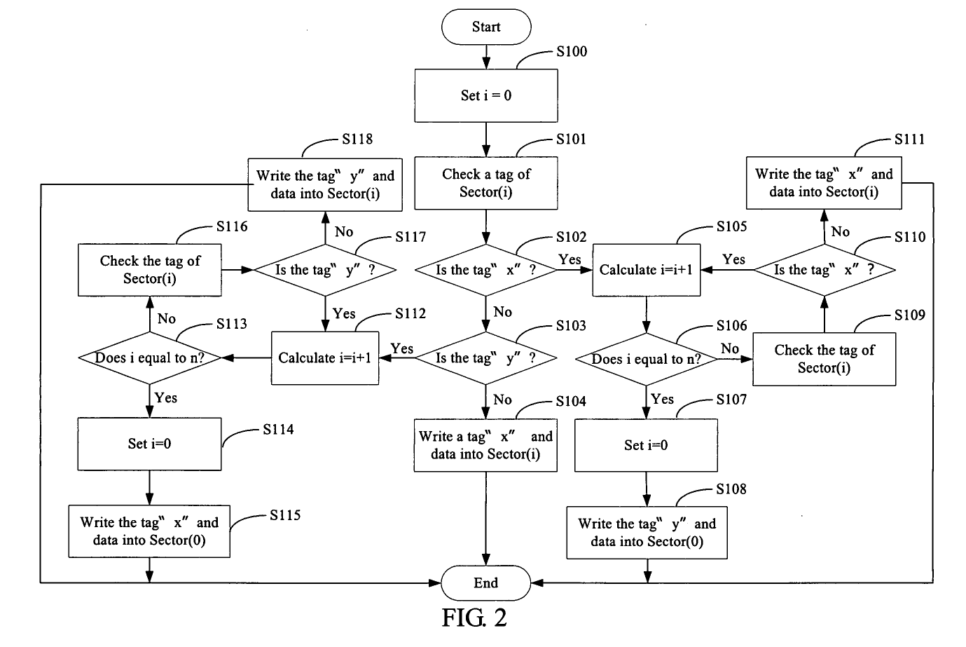

FIG. 2 is a flowchart of a preferred method for prolonging usage lifetime of a non-volatile memory by implementing the system of FIG. 1. In step S100, the host 2 sets i as “0,” wherein i is a parameter which denotes a serial number of a sector 10. That is, the data pointer 23 points at sector(0). In step S101, the sector tag checking module 22 checks a sector tag of sector(i). Then in step S102, the sector tag checking module 22 determines whether the sector tag of sector(i) is “x.” If the sector tag is “x,” the procedure goes directly to step S105 described below. Otherwise, if the sector tag is not “x,” in step S103, the sector tag checking module 22 determines whether the sector tag of sector(i) is “y.” If the sector tag is “y,” the procedure goes directly to step S112 described below. Otherwise, if the sector tag is not “y,” in step S104, the data writing module 20 writes data into sector(0), and writes a tag “x” into sector(0).

In step S105, the host 2 calculates i=i+1. The data pointer 23 points at sector(1). In step S106, the host 2 determines whether i equals to N, wherein N is a total number of sectors 10 of the non-volatile memory 1. That means the host 2 determines whether sector(i) is the last sector 10. If i does not equal to N, the procedure goes directly to step S109 describe below. Otherwise, if i equals to N, in step S107, the host 2 sets i as “0.” That means the data point 23 points at sector(0) again. In step S108, the data writing module 20 writes data into sector(0), and writes the tag “y” into the sector(0). In step S109, the sector tag checking module 22 checks the sector tag of sector(i). Then in step S110, the sector tag checking module 22 determines whether the sector tag of sector(i) is “x.” If the sector tag is “x,” the procedure returns to step S105 described above. Otherwise, if the sector tag is not “x,” in step S111, the data writing module 20 writes data into sector(i), and writes the tag “x” into sector(i).

In step S112, the host 2 calculates i=i+1. In step S113, the host 2 determines whether i equals to N. If i does not equal to N, the procedure goes to step S116 describe below. Otherwise, if i equals to N, in step S114, the host 2 sets i as “0.” In step S115, the data writing module 20 writes data into sector(0), and writes the tag “x” into sector(0). In step S116, the sector tag checking module 22 checks the sector tag of sector(i). Then in step S117, the sector tag checking module 22 determines whether the sector tag of sector(i) is “y.” If the sector tag of sector(i) is “y,” the procedure returns to step S112 described above. Otherwise, if the sector tag of sector(i) is not “y,” in step S118, the data writing module 20 writes data into sector(i), and writes the tag “y” into sector(i).

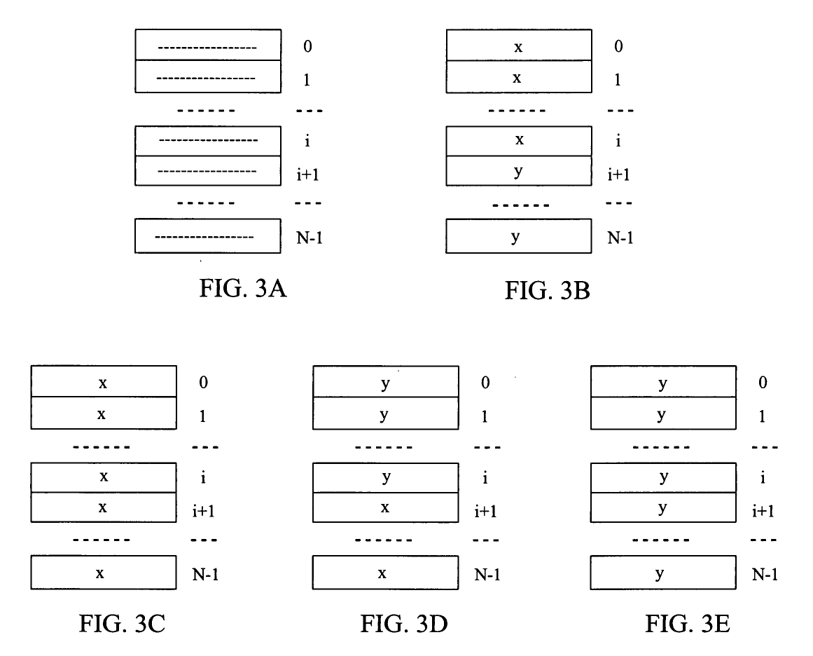

FIG. 3A-3E are schematic diagrams of different instances for writing data into the sectors 10 of the non-volatile memory 1 by utilizing the system. Before the host 2 writes data into the non-volatile memory 1, the sector tag checking module 22 needs to check a type of sector tag in each sector 10, and determines which sector 10 data should be written into.

In FIG. 3A, the sector tag checking module 22 detects there is no tag “x” or tag “y” in any of the sectors 10. Then, the data writing module 20 writes data from sector(0), and writes the tag “x” into sector(0).

In FIG. 3B, the sector tag checking module 22 detects there is a tag “x” in each sector 10 from sector(0) to sector(i), but no tag “x” is in sector(i+1). Then, the data writing module 20 writes data into sector(i+1), and writes the tag “x” into sector(i+1).

In FIG. 3C, the sector tag checking module 22 detects there is a tag “x” in each sector 10 from sector(0) to sector(N−1). Then, the data writing module 20 writes data into sector(0), and writes the tag “y” into sector(0).

In FIG. 3D, the sector tag checking module 22 detects there is a tag “y” in each sector 10 from sector(0) to sector(i), but no tag “y” is in sector(i+1). Then, the data writing module 20 writes data into sector(i+1), and writes the tag “y” into sector(i+1).

In FIG. 3E, the sector tag checking module 22 detects there is a tag “y” in each sector 10 from sector(0) to sector(N−1). Then, the data writing module 20 writes data into sector(0), and writes the tag “x” into sector(0).

Although the present invention has been specifically described on the basis of a preferred embodiment and preferred method, the invention is not to be construed as being limited thereto. Various changes or modifications may be made to the embodiment and method without departing from the scope and spirit of the invention.

We claim:

1. A computer system for prolonging usage lifetime of a non-volatile memory, the non-volatile memory being logically divided into a plurality of sectors, each of the sectors being for storing a sector tag and data, the system comprising a host, the host comprising:
a data writing module for writing data into each sector of the non-volatile memory, and reading data from each sector;
a sector tag writing module for writing a type of sector tag into each sector of the non-volatile memory according to a sector tag writing rule; and
a sector tag checking module for checking a type of sector tag of each sector of the non-volatile memory, in order to determine a sector which data should be written into, and determine which type of sector tag should be written into the sector.

2. The system according to claim 1, wherein the non-volatile memory is one of a flash read only memory (ROM), an electrically erasable programmable read only memory (EEPROM), and a ferroelectric-based random access memory (FRAM).

3. The system according to claim 1, wherein the host further comprises a data pointer for pointing at a location of the sector to be read and/or written a sector tag and/or data.

4. The system according to claim 1, wherein the sector tag writing rule includes:
writing a first sector tag into a sector, if the data writing module has written data into the sector for odd times; and
writing a second sector tag into a sector, if the data writing module has written data into the sector for even times.

5. A computerized method for prolonging usage lifetime of a non-volatile memory, the non-volatile memory being divided into a plurality of sectors, each of the sectors being for storing a sector tag and data, the method comprising the steps of:
determining a sector of the non-volatile memory which data should be written into;
writing a sector tag into the sector according to a sector tag writing rule; and
writing data into the corresponding sector.

6. The method according to claim 5, wherein the step of determining a sector of the non-volatile memory which data should be written into comprises the steps of:
identifying a type of sector tag in the first sector of the non-volatile memory;
checking a type of sector tag in a next sector of the non-volatile memory;
determining whether the sector tag of the sector is the same as the sector tag in the first sector;
returning to the checking step if the sector tag of the sector is the same as the sector tag in the first sector; and
determining the sector is the sector which data should be written into if the sector tag of the sector is not the same as the sector tag in the first sector.

7. The method according to claim 5, wherein the sector tag writing rule includes:
writing a first sector tag into a sector, if data have been written into the sector for odd times; and
writing a second sector tag into a sector, if data have been written into the sector for even times.

8. A method for using a non-volatile memory having a plurality of sectors for processing data thereon, comprising the steps of:
providing a first way and a second way of data processing on a plurality of sequentially identifiable sectors of a non-volatile memory;
verifying data of said plurality of sectors in order so as to identify ways of said data processing;
processing data by using said first way starting from a first available sector out of said plurality of verified sectors under a situation selective from verified situations when none of said plurality of verified sectors is identified as using both of said first and second ways, when all of said plurality of verified sectors are identified as using said second way, and when prior sectors of said plurality of verified sectors are identified as using said first way and others are not; and
processing data by using said second way starting from another first available sector out of said plurality of verified sectors under a situation selective from verified situations when said prior sectors of said plurality of verified sectors are identified as using said second way and others are not, and when all of said plurality of verified sectors are identified as using said first way.

9. The method according to claim 8, wherein said first way to process data is processing data on a selective sector out of said plurality of sectors together with a first type of sector tags, and said second way to process data is processing data on a selective sector out of said plurality of sectors together with a second type of sector tags.
